(19) United States
(12) Patent Application Publication
(10) Pub. No.: US 2023/0385605 A1
(43) Pub. Date: Nov. 30, 2023

(54) Complementary Networks for Rare Event Detection

(71) Applicant: Microsoft Technology Licensing, LLC, Redmond, WA (US)

(72) Inventor: Xinjian XUE, Carmel, IN (US)

(21) Appl. No.: 17/824,406

(22) Filed: May 25, 2022

(51) Int. Cl. G06N 3/04; G06N 3/08

(52) U.S. Cl. CPC G06N 3/0454; G06N 3/08

(57) ABSTRACT

A computer implemented method of identifying rare events includes receiving information representative of an event. A first machine learning network trained to classify events in a majority class is executed on the received information representative of the event. A second machine learning network trained to classify events in a minority class is executed on the received information representative of the event. The first and second machine learning networks may be executed in parallel or serially. The classifications of the first and second machine learning networks are then combined to predict the class of the information representative of the event.

### BACKGROUND

Using deep neural networks for detecting rare events from a large number of events can be difficult. Events corresponding to hardware and software changes can occur daily and in large numbers. It can be difficult to determine which such events might cause problems with proper operation of the hardware and software. Neural networks can be trained using a training set of labeled events, but the number of rare events in the training set is small. The rare events occur quite infrequently and have a large variance in appearance. The use of common classification methods cannot precisely detect the rare events.

### SUMMARY

A computer implemented method of identifying rare events includes receiving information representative of an event. A first machine learning network trained to classify events in a majority class is executed on the received information representative of the event. A second machine learning network trained to classify events in a minority class is executed on the received information representative of the event. The first and second machine learning networks may be executed in parallel or serially. The classifications of the first and second machine learning networks are then combined to predict the class of the information representative of the event.

### BRIEF DESCRIPTION OF THE DRAWINGS

FIG. 1 is a block diagram of an improved rare and extremely rare event detection system according to an example embodiment.

FIG. 2 is a block flow diagram of a system for training complementary deep neural networks (DNNs) according to an example embodiment.

FIG. 3 is a flow diagram illustrating a method of generating a training dataset according to an example embodiment.

FIG. 4 shows example event patterns for example respective training and testing sets with a point corresponding to each datapoint according to an example embodiment.

FIG. 5 is a flowchart of a computer implemented method for using complementary classifiers to identify rare events according to an example embodiment.

FIG. 6 is a block schematic diagram of a computer system to implement one or more example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

In a cloud computing environment, such as in Microsoft Azure, millions of hardware and software changes, referred to as deployments, may be made every day to maintain the health of the cloud computing environment and services that are supported. Some of these changes may cause incidents that adversely affect the performance of the cloud computing environment and services after rollout. Such incidents, referred to as culprits, may cause disruption of certain cloud services. The last opportunity to prevent change-caused incident/outage is the moment that the deployment media and request have been sent to a Change Management System (CMS) and are waiting for final approval before being launched. The CMS assesses the change risk regarding the possibility of causing incidents if implemented and then grants or rejects (declaims) the change request accordingly.

Based on an accumulated dataset in Azure Federated Change Management (FCM) and human experience on the patterns of change-caused incidents, it is possible to train machine learning models to assess the change risk and flag or prevent culprit changes from occurring. From the artificial intelligence perspective, this prevention problem can be modeled as a binary classification problem. When a change request is presented, the model predicts that a change is elevated risk (Class 1, culprit change) or insignificant risk (Class 0, normal change) with a certain probability of causing incidents if implemented. Since the culprit changes happen few and far apart with large variance in characters corresponding to the change, common classification methods cannot precisely detect culprit changes.

In many rare event examples, the distribution of data across known classes of events is often biased or skewed. Depending on the extent of the imbalance, in a so-called unbalanced dataset, the positively labeled datapoints (Class 1) are 10-40% of the total datapoints. In a rare event dataset, this portion is less than 10% or around 5-10% of the total events. In an extremely rare event dataset, one percent or less are positively labeled as Class 1 rare events. Extremely rare event problems are not uncommon in industry, for example, major machinery failures in manufacturing, and earthquakes in seismology.

Binary classification is a supervised learning approach in which the computer program learns from a training dataset and classifies unseen datapoints from a similar distribution as the training dataset. Recently, Deep Learning has been extensively used in classification. The Deep Learning is realized by a Deep Neural Network (DNN) which is a collection of neurons organized in a sequence of multiple layers, where neurons receive as input the neuron activations from the previous layer, and perform a simple mathematical computation (e.g., a weighted sum of the input followed by a nonlinear activation). The neurons of the network jointly implement a complex nonlinear mapping from the input to the output. This mapping is learned from the labeled datapoints by adapting the weights of each neuron using error backpropagations. In an inference phase, the trained DNN labels unseen datapoints to one of the classes.

Classifying rare and extremely rare events is quite challenging due to the limited amount of positively labeled samples. Majority class centric methods, such as a one-class anomaly classifier has been used to detect such events. Minority class centric methods, such as few-shot centroid and Siamese networks have also been used. However, directly applying majority or minority centric methods to solving the extreme rare event detection problem are likely to suffer high false negative errors for majority centric methods or high false positive errors for minority centric methods. Complementary neural networks offer another school of thought and demonstrate that with k-neural networks of the same structure and parameters and each is a one-over-all classifier, they could better solve k-class classification for unbalanced datasets.

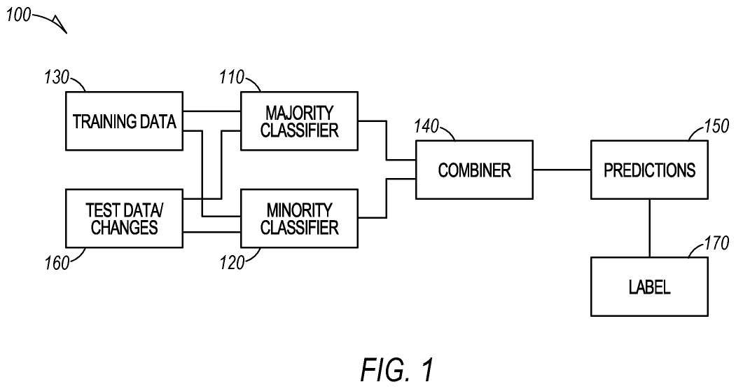

FIG. 1 is a block diagram of an improved rare and extremely rare event detection system 100. System 100 includes a pair of complementary neural networks with a majority centric classifier 110 and a minority centric classifier 120 trained with the same dataset 130. The majority and minority centric neural networks may be deep neural networks (DNNs) in one example. The complimentary neural networks are complemental to each other because they focus on different classes in the dataset.

Based on the application requirements, say to minimize the false negative or to minimize the false positive in prediction of minority class, a combiner 140 implements a voting algorithm to summarize the classifiers' predictions 150 for input changes 160 and generate a final label 170 for an unseen datapoint. The pair of complementary neural networks combines the discrimination power of complemental models and computes a prediction output with a voting algorithm to provide flexible method that is adaptable to different rare event and extreme rare event detection scenarios.

Combiner 140 may implement a hard voting ensemble in one example by summing the votes for the class labels from the classifiers, also referred to as models, and predicting the class with the most votes. A soft voting ensemble involves summing the predicted probabilities for class labels and predicting the class label with the largest sum probability.

A voting ensemble can offer lower variance in the predictions made over individual models. This lower variance may result in a lower mean performance of the ensemble, which might be desirable given the higher stability or confidence of the model. In one example, a voting ensemble results in better performance than any single model used in the ensemble, and it results in a lower variance than any single model used in the ensemble.

In one example, the majority centric classifier 110 produces a result A on unseen or test data 160. The test data 160 may be either reserved data from a set of training data 130, or actual changes occurring during use of a fully trained system 100. The minority centric classifier 120 may produce a result F. The combiner 140 combines the results A and F to produce a system result C, or label 160.

In one example, the system result C is simply the intersection of A and F. This essentially means that the only rare events identified, are the rare events identified by both classifiers. The intersection of A and F reduced false positives to zero or near zero. The combiner may alternatively utilize a union of A and F to enhance minority class or rare event identification. The union and intersection methods are referred to as hard-voting algorithms.

In further examples, soft-voting algorithms may be used. A soft-voting algorithm may utilize a weighted combination or sum of probabilities of each model that is compared to a rare event threshold to identify rare or extremely rare events. In one example, the rare event threshold may be 0.5. The threshold may be adjusted over time to identify more or fewer rare or extremely rare events.

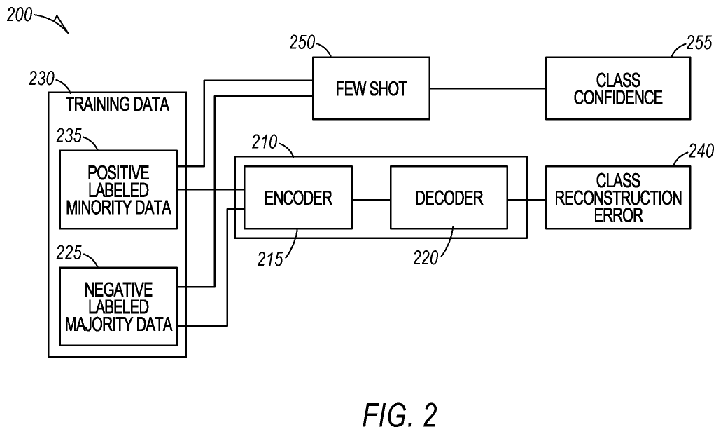

FIG. 2 is a block flow diagram of a system 200 for training complementary DNNs. Anomaly detection methods share the characteristics of majority class centricity. In one example, an autoencoder 210 is used as a majority classifier. Other regression type DNNs, such as Deep Feed Forward Networks may be used in further examples. The autoencoder approach for classification is like anomaly detection in which the pattern or behavior of a normal (majority) class is learned. Anything that does not follow this pattern is classified as an anomaly and thus minority class behavior.

The autoencoder 210 is made of two components, an encoder 215 and a decoder 220. The encoder 215 learns the underlying features of a normal class, shown as negatively labeled majority data at 225, which is a subset of training data 230 that includes only classes that are more common and not the rare or extremely rare culprits. These features are typically in a reduced dimension. The decoder 220 can recreate the original data from these underlying features.

In one example, the training data is divided into two parts: positively labeled data 235 and negatively labeled data 225. The negatively labeled data 225 is treated as a normal class. The autoencoder 210 is trained on only negatively labeled data. After training, the autoencoder 210 has learned the features of the normal, majority class. A well-trained autoencoder 210 will predict any new data that is coming from the majority class identified by a low reconstruction error 240. However, in trying to reconstruct a datapoint from a rare event, the autoencoder 210 will struggle and result in a high reconstruction error. Such a high reconstruction error can be noted and labeled as a rare event.

In one example, a minority centric classifier, such as a few-shot DNN 250 can be trained on the rare or extremely rare positive labeled data 235. There are fewer minority class centric methods available. Other examples include centroid, data augment, meta learning, and metric learning. The limitation of only one or very few samples in a minority class challenges the standard fine-tuning method in deep learning. Few-shot learning is devoted to resolving the data deficiency problem by recognizing novel classes from very few labeled examples and provide a class confidence 255.

Among variations of few-shot learning, the distance metric learning is an approach that entails certain complexity when learning the targeted few-shot problem. The core idea in metric-based few-shot learning is like nearest neighbors and kernel density estimation. The predicted probability over a set of known labels is a weighted sum of labels of support sets. In one example, the few shot DNN 250 may be a weighted K-nearest neighbor classifier measured by the cosine distance, called Matching Networks (MN). Using an NM-like classifier as the minority centric model enables recognizing that the minority class may be centralized in multiple pockets.

In one example, a small cloud-based system may have twenty or more changes made to it every day on average. Occasionally, incidents are reported that were identified as caused by one or more of the changes. The event detection system 100, 200 can be used to predict if a change could cause incidents if a change is deployed.

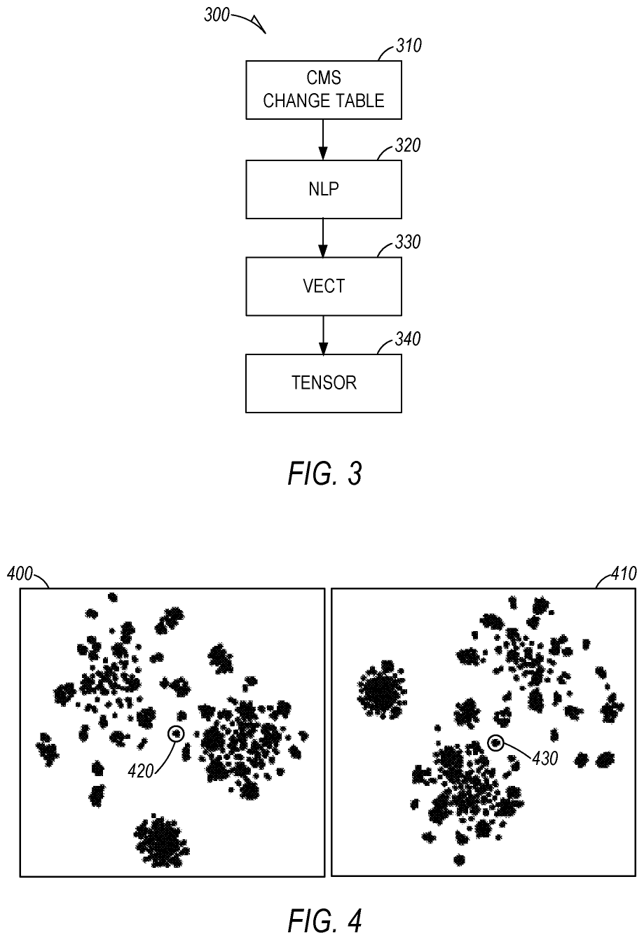

FIG. 3 is a flow diagram illustrating a method 300 of generating a training dataset, such as training dataset 130, 230. The training dataset 130, 230 may be generated from an example change management system table 310 that includes 4,042 datapoints (changes) accumulated in a period of six months. The number of datapoint and time period are for example only and may vary significantly in further examples. Among the datapoints, forty-two changes are identified as having caused incidents after rollout or deployment. Each change is represented in the change management system by twenty alphanumerical values. Each change may be labeled as
0: normal change
1: abnormal change as it caused incident, thus a culprit

The label distribution of the training dataset evidences an extremely rare event problem based on the criteria defined above. Further, the alphanumerical values can be preprocessed with Natural Language Process (NLP) 320 to produce an alphanumeric vector 330 and resultant numerical tensor 340:

```
<tf.Tensor: shape=(2021, 512), dtype=float32, numpy=
array([[ 0.04318225, −0.04454158, −0.0507233 , ..., 0.05449447,
    0.05190226, −0.03165738],
  [ 0.0258806 , −0.05318251, −0.04149484, ..., 0.05473251,
    0.04275873, −0.01250669],
```

In one example, the preprocessed dataset may be randomly stratified to partition the preprocessed dataset into two equal sized subsets, one for training and the other for testing, with each subset including 21 culprit changes. The distributions of training and testing sets will have a similar pattern. The above tensor is an example one of the subsets, having 2021 rows of 512 columns, each row corresponding to a datapoint.

To illustrate the power of using complementary DNNs with a combiner in reducing false positives, the test data 160 was applied to autoencoder 210 in one example resulting in 1999 of the 2000 majority class events being properly classified. 9 of the 21 minority class events were properly classified. The few shot DNN 250 classified 1996 of the 200 majority class events as not being rare events and 9 of the 21 rare events as rare events. When combined, all 2000 of the majority events were properly classified, and 7 of the 21 rare or minority events were labeled with zero false positives.

FIG. 4 shows example event patterns at 400 and 410 for example respective training and testing sets with a point corresponding to each datapoint after mapping the tensor to a T-distributed Stochastic Neighbor Embedding plane. The minority datapoints, Class 1, are enclosed at 420 and 430 respectively. The majority datapoints, Class 0, may form clusters and are shown as surrounding the minority datapoints.

The problem is how to extract the pattern out from the training dataset. The difficulties are: (1) there are overwhelmingly more Class 0 datapoints and (2) the Class 1 datapoints are clustered within the Class 0 datapoints. This structure makes it difficult to find clear boundaries to separate these two classes.

For this kind of classification problem, simply using a majority centric model (outside-in), or a minority centric model (inside-out), the results would not be satisfactory. However using paired complementary DNNs, the majority centric model aims to draw boundaries to enclose the majority class datapoints through their characteristics, so it is focused on classifying from the outside and stops at the inner enclosure 420. While a minority centric model is focused on the centroid of the inner enclosure 420 and try to draw the bounders to surround it.

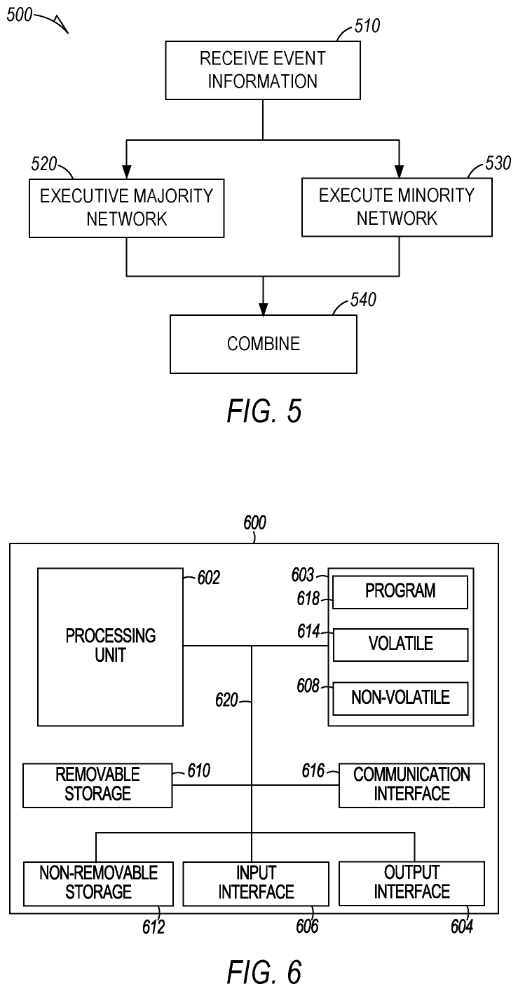

FIG. 5 is a flowchart of a computer implemented method 500 for using complementary classifiers to identify rare events. Method 500 begins at operation 510 by receiving information representative of an event. A first machine learning network is executed at operation 520 on the received information representative of the event. The first machine learning network is trained to classify events in a majority class. The first machine learning network may be a regression type of network such as an encoder decoder deep neural network classifier that operates well on identifying one or more common classes that were well represented in training data.

A second machine learning network is executed at operation 530 on the received information representative of the event. Operations 520 and 530 may run in parallel or serially. The second machine learning network is trained to classify events in a minority class, wherein very few minority class events were included in training data. The second machine learning network may be a few shot deep neural network classifier or other classifier that operates well with few training examples. In one example, the few shot deep neural network classifier comprises a weighted K-nearest neighbor classifier.

At operation 540, classifications of the first and second machine learning models are combined to predict the class of the information representative of the event. Operation 540 may combine the classifications based on a union or intersection of rare event classifications by both models. In further examples, a weighted combination of rare event classification probabilities may be compared to a rare event threshold to determine a classification of an event as a rare event.

FIG. 6 is a block schematic diagram of a computer system 600 to implement complementary models for identifying rare events and for performing methods and algorithms according to example embodiments. All components need not be used in various embodiments.

One example computing device in the form of a computer 600 may include a processing unit 602, memory 603, removable storage 610, and non-removable storage 612. Although the example computing device is illustrated and described as computer 600, the computing device may be in different forms in different embodiments. For example, the computing device may instead be a smartphone, a tablet, smartwatch, smart storage device (SSD), or other computing device including the same or similar elements as illustrated and described with regard to FIG. 6. Devices, such as smartphones, tablets, and smartwatches, are generally collectively referred to as mobile devices or user equipment.

Although the various data storage elements are illustrated as part of the computer 600, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 603 may include volatile memory 614 and non-volatile memory 608. Computer 600 may include—or have access to a computing environment that includes—a variety of computer-readable media, such as volatile memory 614 and non-volatile memory 608, removable storage 610 and non-removable storage 612. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 600 may include or have access to a computing environment that includes input interface 606, output interface 604, and a communication interface 616. Output interface 604 may include a display device, such as a touchscreen, that also may serve as an input device. The input interface 606 may include one or more of a touchscreen, touchpad, mouse, keyboard, camera, one or more device-specific buttons, one or more sensors integrated within or coupled via wired or wireless data connections to the computer 600, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 600 are connected with a system bus 620.

Computer-readable instructions stored on a computer-readable medium are executable by the processing unit 602 of the computer 600, such as a program 618. The program 618 in some embodiments comprises software to implement one or more methods described herein. A hard drive, CD-ROM, and RAM are some examples of articles including a non-transitory computer-readable medium such as a storage device. The terms computer-readable medium, machine readable medium, and storage device do not include carrier waves or signals to the extent carrier waves and signals are deemed too transitory. Storage can also include networked storage, such as a storage area network (SAN). Computer program 618 along with the workspace manager 622 may be used to cause processing unit 602 to perform one or more methods or algorithms described herein.

### Examples

1. A computer implemented method of identifying rare events includes receiving information representative of an event. A first machine learning network trained to classify events in a majority class is executed on the received information representative of the event. A second machine learning network trained to classify events in a minority class is executed on the received information representative of the event. The first and second machine learning networks may be executed in parallel or serially. The classifications of the first and second machine learning networks are then combined to predict the class of the information representative of the event.

2. The method of claim 1 wherein the first machine learning network includes an encoder decoder deep neural network classifier.

3. The method of example 2 wherein the received information representative of the event includes a tensor derived from natural language processing of a change table.

4. The method of any of examples 1-3 wherein the first machine learning network is trained with majority class training data such that minority class events are classified with a lower confidence level than majority class events.

5. The method of any of examples 1-4 wherein the second machine learning network comprises a few shot deep neural network classifier.

6. The method of example 5 wherein the few shot deep neural network classifier comprises a weighted K-nearest neighbor classifier.

7. The method of any of examples 1-6 wherein rare events include less than 10% of events.

8. The method of any of examples 1-6 wherein rare events include 1% or less of events.

9. The method of any of examples 1-8 wherein combining classifications of the first and second machine learning models to predict the class of the information representative of the event includes performing a union of events classified by both models as rare events.

10. The method of any of examples 1-8 wherein combining classifications of the first and second machine learning models to predict the class of the information representative of the event includes performing an intersection of events classified by both models as rare events.

11. The method of any of examples 1-8 wherein combining classifications of the first and second machine learning models to predict the class of the information representative of the event includes performing a combination of predicted probabilities of events classified by both models as rare events compared to a rare event threshold.

12. The method of any of examples 1-8 wherein combining classifications of the first and second machine learning models to predict the class of the information representative of the event includes performing a weighted combination of predicted probabilities of events classified by both models as rare events compared to a rare event threshold.

13. The method of any of examples 1-12 wherein the events include changes made to a cloud-based system.

14. A machine-readable storage device has instructions for execution by a processor of a machine to cause the processor to perform operations to perform any of the methods of examples 1-13.

15. A device includes a processor and a memory device coupled to the processor and having a program stored thereon for execution by the processor to perform operations to perform operations to perform any of the methods of examples 1-13.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A computer implemented method comprising:
receiving information representative of an event;
executing a first machine learning network on the received information representative of the event, the first machine learning network trained to classify events in a majority class;
executing a second machine learning network on the received information representative of the event, the second machine learning network trained to classify events in a minority class; and
combining classifications of the first and second machine learning networks to predict the class of the information representative of the event.

2. The method of claim 1 wherein the first machine learning network comprises an encoder decoder deep neural network classifier.

3. The method of claim 2 wherein the received information representative of the event comprises a tensor derived from natural language processing of a change table.

4. The method of claim 1 wherein the first machine learning network is trained with majority class training data such that minority class events are classified with a lower confidence level than majority class events.

5. The method of claim 1 wherein the second machine learning network comprises a few shot deep neural network classifier.

6. The method of claim 5 wherein the few shot deep neural network classifier comprises a weighted K-nearest neighbor classifier.

7. The method of claim 1 wherein rare events comprise less than 10% of events.

8. The method of claim 1 wherein rare events comprise 1% or less of events.

9. The method of claim 1 wherein combining classifications of the first and second machine learning models to predict the class of the information representative of the event comprises performing a union of events classified by both models as rare events.

10. The method of claim 1 wherein combining classifications of the first and second machine learning models to predict the class of the information representative of the event comprises performing an intersection of events classified by both models as rare events.

11. The method of claim 1 wherein combining classifications of the first and second machine learning models to predict the class of the information representative of the event comprises performing a combination of predicted probabilities of events classified by both models as rare events compared to a rare event threshold.

12. The method of claim 1 wherein combining classifications of the first and second machine learning models to predict the class of the information representative of the event comprises performing a weighted combination of predicted probabilities of events classified by both models as rare events compared to a rare event threshold.

13. The method of claim 1 wherein the events comprise changes made to a cloud-based system.

14. A machine-readable storage device having instructions for execution by a processor of a machine to cause the processor to perform operations to perform a method, the operations comprising:
receiving information representative of an event;
executing a first machine learning network on the received information representative of the event, the first machine learning network trained to classify events in a majority class;
executing a second machine learning network on the received information representative of the event, the second machine learning network trained to classify events in a minority class; and
combining classifications of the first and second machine learning networks to predict the class of the information representative of the event.

15. The device of claim 14 wherein the first machine learning network comprises an encoder decoder deep neural network classifier and wherein the second machine learning network comprises a few shot deep neural network classifier.

16. The device of claim 14 wherein the first machine learning network is trained with majority class training data such that minority class events are classified with a lower confidence level than majority class events.

17. The device of claim 14 wherein combining classifications of the first and second machine learning models to predict the class of the information representative of the event comprises performing a union, an intersection, or a combination of predicted probabilities of events classified by both models as rare events.

18. A device comprising:
a processor; and
a memory device coupled to the processor and having a program stored thereon for execution by the processor to perform operations comprising:
receiving information representative of an event;
executing a first machine learning network on the received information representative of the event, the first machine learning network trained to classify events in a majority class;
executing a second machine learning network on the received information representative of the event, the second machine learning network trained to classify events in a minority class; and
combining classifications of the first and second machine learning networks to predict the class of the information representative of the event.

19. The device of claim 18 wherein the first machine learning network comprises an encoder decoder deep neural network classifier and wherein the second machine learning network comprises a few shot deep neural network classifier.

20. The device of claim 18 wherein the first machine learning network is trained with majority class training data such that minority class events are classified with a lower confidence level than majority class events.
